(19) United States
(12) Patent Application Publication
(10) Pub. No.: US 2018/0045131 A1
(43) Pub. Date: Feb. 15, 2018

(54) COMBUSTION PHASING CONTROL TECHNIQUES USING A PHYSICS-BASED COMBUSTION MODEL

(71) Applicant: Brian Rockwell, Auburn Hills, MI (US)

(72) Inventor: Brian Rockwell, Auburn Hills, MI (US)

(21) Appl. No.: 15/233,398

(22) Filed: Aug. 10, 2016

(51) Int. Cl. F02D 41/14; F02D 41/26; F02P 5/15; F02D 41/00

(52) U.S. Cl. CPC F02D 41/1401; F02D 41/009; F02D 41/263; F02P 5/1502; F02D 2041/1433; F02D 2041/1412; F02D 2250/26

(57) ABSTRACT

A control system includes an ignition system configured to generate spark within a cylinder of an engine and a controller. The controller is configured to obtain a target angle of the crankshaft for an approximately 50% mass fraction burn (MFB50) and predict an ignition angle to achieve the target MFB50 angle, the ignition angle indicating an advance or retardation of spark timing. Using a combustion model, the controller is configured to generate a modeled MFB50 angle based on the predicted ignition angle and, based on the target and modeled MFB50 angles and the predicted ignition angle, determine a relationship between MFB50 angle and ignition angle. The controller is also configured to control the ignition system using the determined relationship.

### FIELD

The present application generally relates to engine combustion control and, more particularly, to combustion phasing control techniques using a physics-based combustion model.

### BACKGROUND

A spark-ignition engine compresses and combusts an air/fuel mixture within a cylinder to drive a piston that rotatably turns a crankshaft to generate drive torque. The compressed air/fuel mixture is ignited by a spark that is generated by an ignition system. The timing of the spark and the resulting combustion phasing with respect to a rotational angle of the crankshaft, affects the torque generated by the engine as well as the efficiency with which it is generated. Thus, precise ignition timing control is necessary.

Conventional engines utilize empirical-based ignition control techniques. More particularly, a large amount of test data is gathered and utilized to calibrate ignition timing for varying operating conditions. This approach is expensive in both calibration time and resources (e.g., test properties and facilities). Additionally, they adjust for changes in operating conditions (e.g., engine speed and load, charge air temperature and humidity, and intake and exhaust valve phasing) only to the extent that the effects on combustion timing have been accurately captured through an empirical relationship.

Empirical spark control generally works well under the nominal calibration conditions, but loses accuracy as conditions move away from these nominal conditions. This loss of accuracy is especially apparent if multiple parameters are different from the nominal condition as empirically capturing the interactions between deviations from nominal in multiple parameters is very difficult. Accordingly, while such ignition control systems work for their intended purpose, there remains a need for improvement in the relevant art.

### SUMMARY

According to an aspect of the invention, a control system for an engine having a crankshaft is presented. In one exemplary implementation, the control system includes an ignition system configured to generate spark within a cylinder of the engine and a controller configured to: obtain a target angle of the crankshaft for an approximately 50% mass fraction burn (MFB50); predict an ignition angle to achieve the target MFB50 angle, the ignition angle indicating an advance or retardation of spark timing; using a combustion model, generate a modeled MFB50 angle based on the predicted ignition angle; based on the modeled MFB50 angle and the predicted ignition angle, determine a relationship between MFB50 angle and ignition angle; and control the ignition system using the determined relationship.

In some implementations, determining the relationship includes the controller generating a polynomial function relating MFB50 angle and ignition angle. In some implementations, the controller is configured to regenerate the polynomial function during each startup period of the engine. In some implementations, the controller is further configured to perform an update of the polynomial function by: obtaining the target MFB50 angle from one of a calibratable number of points in the polynomial function; and based on the predicted ignition angle and the modeled MFB50 angle derived from the target MFB50 angle, updating the polynomial function.

In some implementations, the controller is configured to perform the update of the polynomial function at a predetermined rate. In some implementations, the predetermined rate is not related to a firing rate of the engine. In some implementations, the predetermined rate is approximately every ten milliseconds. In some implementations, the predetermined rate is a function of firing frequency. In some implementations, the predetermined rate is once per spark event.

In some implementations, for a firing event of the cylinder, the controller is configured to: determine the target MFB50 angle based on one or more measured engine operating parameters; using the polynomial function, determine a target ignition timing based on the target MFB50 angle; and control the ignition system using the target ignition timing. In some implementations, the controller is configured to determine the target ignition timing a single time per cylinder firing event.

In some implementations, the controller is further configured to perform an update of the polynomial function for the firing event of the cylinder by: predicting an ignition angle required to obtain the target MFB50 angle; using the combustion model, obtaining a modeled MFB50 angle for the predicted ignition angle; based on the predicted ignition and modeled MFB50 angles, updating the polynomial function; using the updated polynomial function, determine a modified target ignition timing based on the target MFB50 angle; and control the ignition system using the modified target ignition timing. In some implementations, the controller is further configured to detect a transient operating condition of the engine, and the controller performs the update of the polynomial function for the firing event of the cylinder in response to detecting the transient operating condition.

In some implementations, the controller only performs the update of the polynomial function for the firing event of the cylinder when it has additional processing capacity. In some implementations, the system further includes one or more sensors configured to measure one or more engine operating parameters, wherein the controller is further configured to receive the one or more measured engine operating parameters.

In some implementations, the controller is further configured to determine the target MFB50 angle based on a maximum brake torque (MBT) that can be generated by the engine. In some implementations, the controller is further configured to determine the target MFB50 angle based on a desired torque to be generated by the engine. In some implementations, the controller is further configured to determine the target MFB50 angle based on a knock-limited torque to be generated by the engine.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a diagram of an example engine system according to the principles of the present disclosure;

FIG. 2 is a functional block diagram of an example control architecture according to the principles of the present disclosure;

FIG. 3A is a graph of an example third order polynomial function relating target 50% mass fraction burn (MFB50) angle to ignition angle;

FIG. 3B is a graph of an example relationship generation during a cranking period and subsequent usage of the relationship to a normal run period;

FIGS. 3C-3D are graphs of an example prediction error during a transient operating period;

FIG. 3E is a graph of an example local update procedure to correct the prediction error during the transient operating period; and

FIG. 4 is a flow diagram of an example method for controlling combustion phasing using a physics-based combustion model according to the principles of the present disclosure.

### DETAILED DESCRIPTION

As mentioned above, empirical-based ignition control techniques require extensive calibration resources and generally do not perform well in off-nominal conditions. Instead of empirical-based techniques, a physics-based, crank-angle-resolved combustion model could be utilized to predict a target mass fraction burn (MFB) angle given an ignition (spark) angle. The MFB angle, for example, could be an approximately 50% MFB angle, also known as “MFB50,” which could correspond to a crankshaft angle at which approximately 50% of the heat generated during combustion is released (also known as “CA50”). To determine the ignition timing given a target MFB50 angle using this combustion model, an iterative solver (e.g., recursive least squares, or RLS) with a polynomial function could be utilized. For each ignition event, the RLS solver could be initialized with a best-guess for the polynomial coefficients and, on each iteration, the polynomial fit could be updated until the predicted MFB50 angle converges with the request.

Such a method, however, requires running the combustion model a plurality of times (e.g., three to five times) per cylinder firing event, which is very computationally expensive and could saturate certain controllers. Accordingly, improved techniques are presented for combustion phasing control using a physics-based combustion model. In contrast to the above-mentioned iterative solver, the disclosed techniques aim to learn the polynomial fit in real-time and at a rate not tied to the firing rate of the engine. This allows the combustion model to be run much less often and at a flexible rate, which significantly decreases the required processing resources. This could result in decreased costs by implementing less expensive controllers or allow for the use of a combustion model when it would be otherwise infeasible. The techniques generally involve learning a relationship (e.g., a third order polynomial function) for target MFB50 crankshaft angle to ignition angle by fitting the polynomial through a calibratable number of points, which are updated cyclically. The ignition angle for each point in the fit is determined through a calibratable target MFB50 (e.g., CA50). This provides a near perfect fit of the MFB50 angle to ignition angle relationship, consistent with existing dynamometer-based empirical approaches.

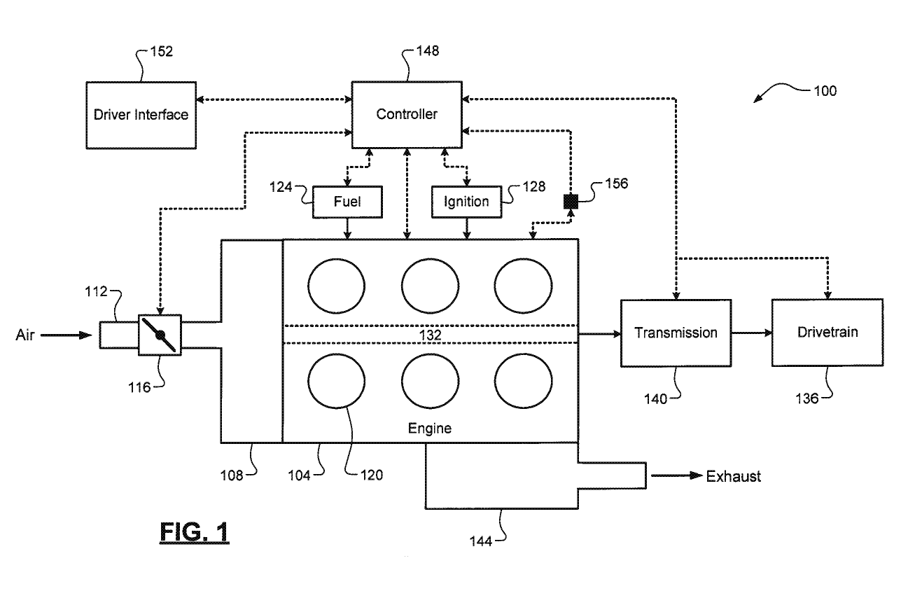

Referring now to FIG. 1, an example engine system 100 is shown. The engine system 100 includes an engine 104. The engine 104 is any suitable spark ignition (SI) engine. The engine 104 draws air into an intake manifold 108 through an induction system 112 that is selectively regulated by a throttle valve 116. The air in the intake manifold 108 is distributed to a plurality of cylinders 120. While six cylinders are shown, it will be appreciated that the engine 104 could include any number of cylinders. The air supplied to the cylinders 120 is also combined with fuel from a fuel system 124 (fuel tank, fuel lines, fuel rail, fuel injectors, etc.) to create an air/fuel mixture.

The air/fuel mixture is compressed within the cylinders 120 by respective pistons (not shown). The compressed air/fuel mixture is ignited within the cylinders 120 by spark provided by an ignition system 128 (ignition coils, spark plugs, etc.). The combustion of the compressed air/fuel mixture within the cylinders 120 drives the respective pistons (not shown), which rotatably turn a crankshaft 132 to generate drive torque. The drive torque is transferred from the crankshaft 132 to a drivetrain 136 (e.g., wheels) via a transmission 140. Exhaust gas resulting from combustion is expelled from the cylinders 120 into an exhaust system 144, which treats the exhaust gas before it is released into the atmosphere.

A controller 148 controls operation of the engine system 100, including controlling airflow (via the throttle valve 116), fuel (via the fuel system 124), and spark (via the ignition system 128). The controller 148 could be an application-specific integrated circuit (ASIC) or a computing device having one or more processors (distributed, parallel, etc.) and a non-transitory memory storing a set of instructions for execution by the processor(s). In particular, the controller 148 controls the engine 104 to generate a desired amount of torque, which could correspond to a torque request received from a driver via a driver interface 152 (e.g., an accelerator pedal). Sensors 156 are configured to measure various operating parameters of the engine 104. Examples of these operating parameters include, but are not limited to, engine load, engine speed, and temperature.

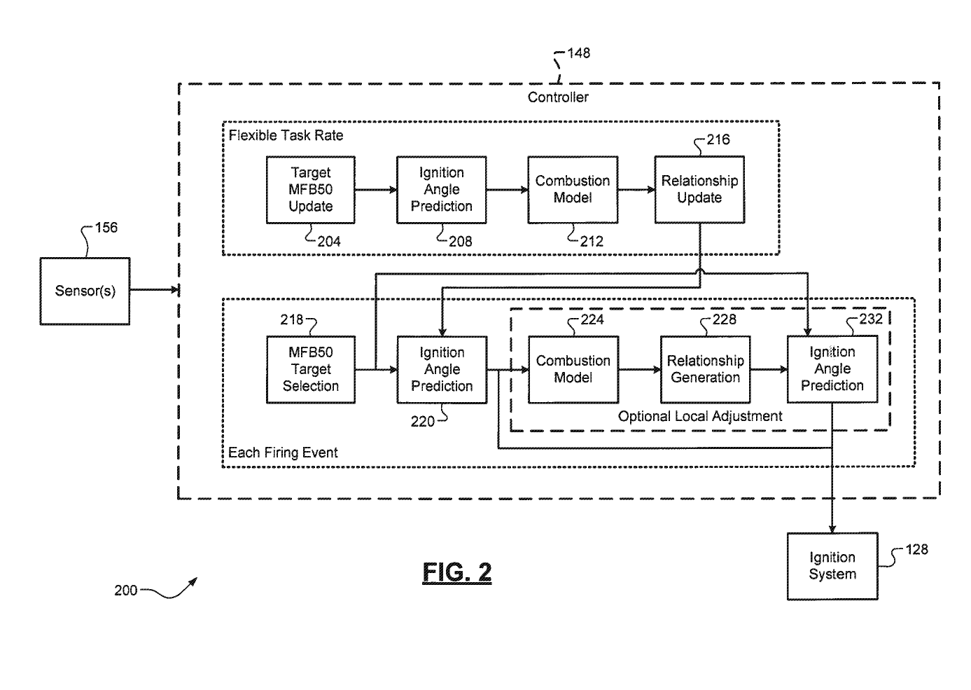

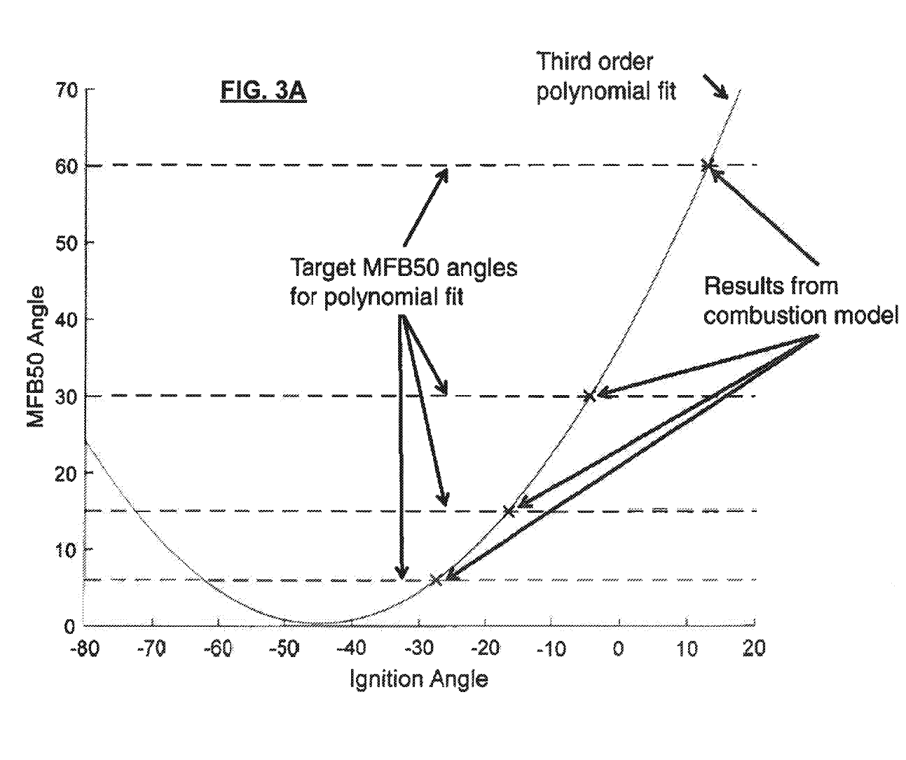

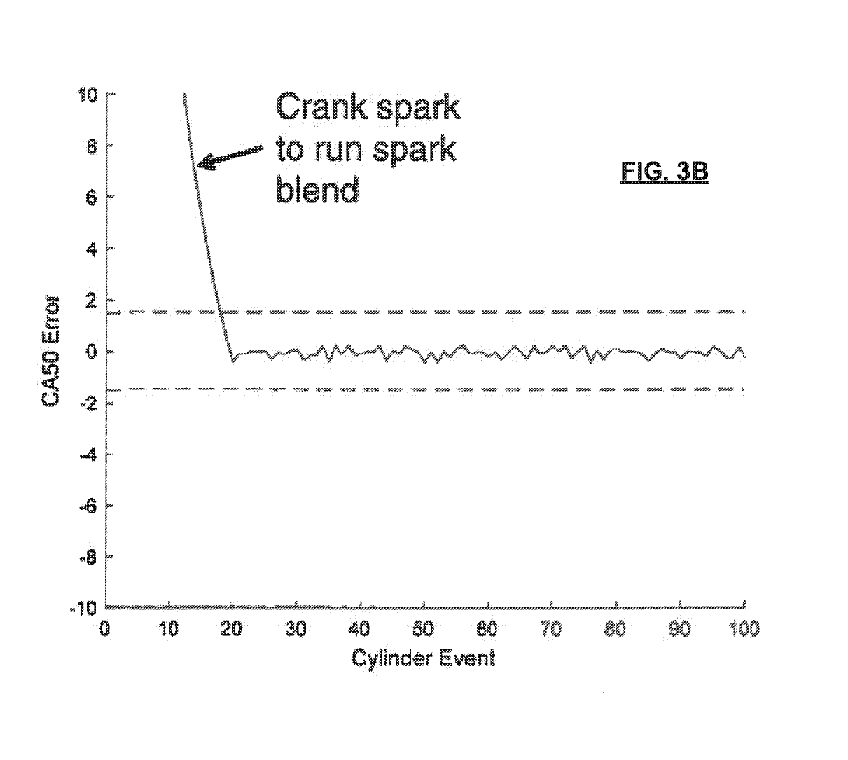

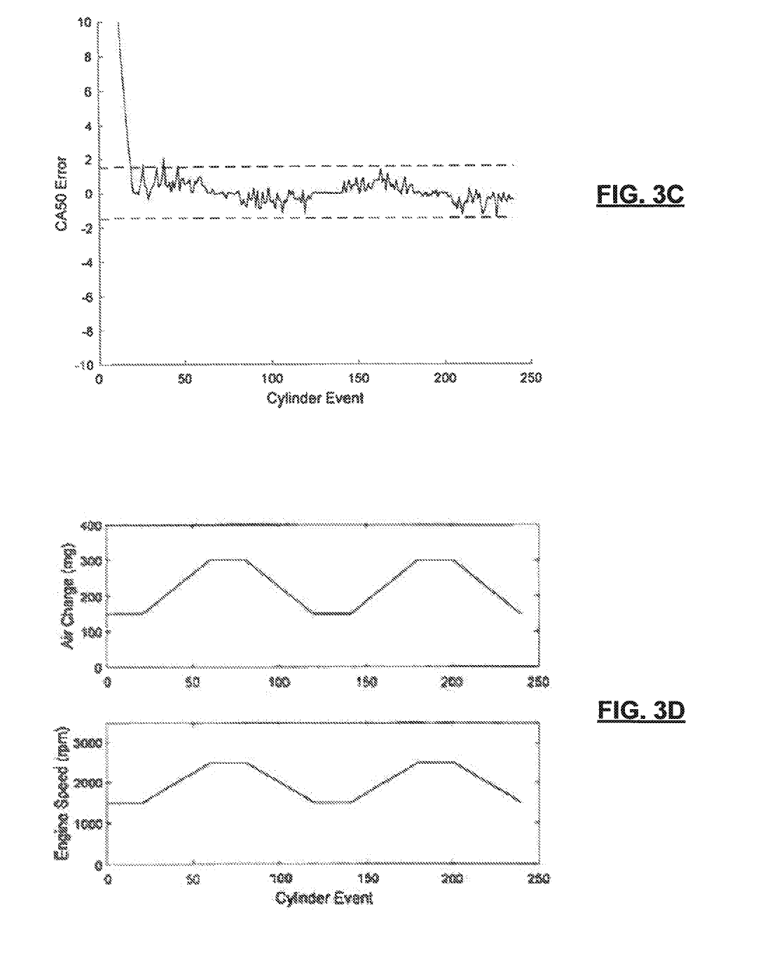

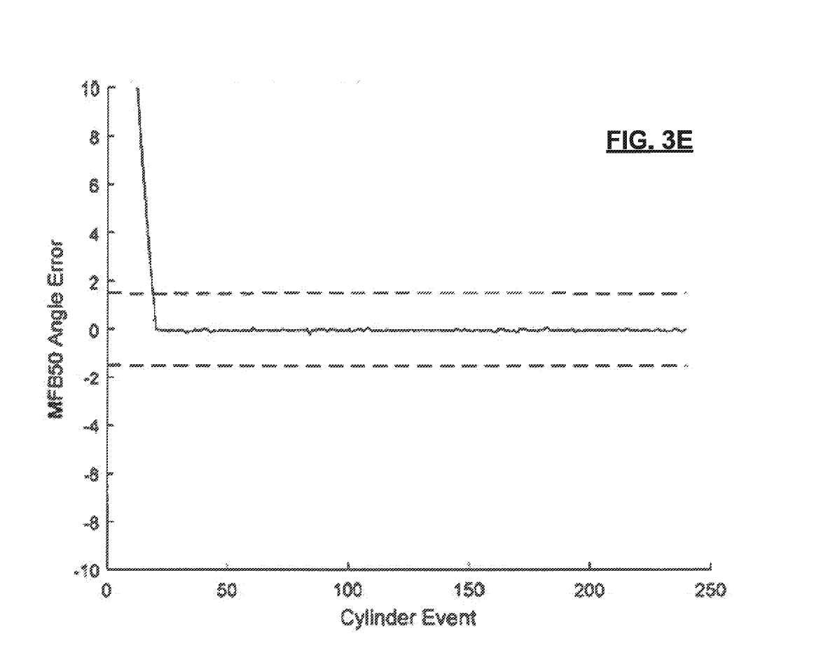

Referring now to FIG. 2, a functional block diagram of an example control architecture 200 implemented by the controller 148 is illustrated. This architecture 200, for example, could be stored as a set of instructions at a memory and executed by processor(s) of the controller 148. At 204, the controller 148 obtains a target MFB50 angle for updating. This is part of a group of operations that operate at a flexible task rate. In other words, this updating need only be performed once every few milliseconds (e.g., once every 10 milliseconds), which is less often than each cylinder firing event. While updating is discussed herein, it will be appreciated that an initial iteration for each target MFB50 angle could also be described as a learn or generation procedure, during which the relationship (e.g., the polynomial function) is generated. This could be performed (i.e., the polynomial function could be relearned) during every start-up of the engine 104. FIG. 3A, for example, illustrates a graph of an example third order polynomial fit. A calibratable number of target MFB50 angles are utilized. As shown, four target MFB50 angles are utilized, which are approximately 5 degrees, 15 degrees, 30 degrees, and 60 degrees.

Referring still to FIG. 2 and FIG. 3A, these target MFB50 angles could be predetermined or calibrated. It will be appreciated that other numbers of target MFB50 angles could be utilized. The controller 148 performs ignition angle prediction at 208. In other words, the controller 148 predicts an ignition angle that should achieve the target MFB50 angle. The predicted ignition angle is fed into the combustion model at 212, which produces a modeled MFB50 angle. This modeled MFB50 angle, the target MFB50 angle, and the predicted ignition angle are used to generate or update the polynomial function at 216. While a third order polynomial function is discussed herein, it will be appreciated that any suitable curve-based relationship could be utilized.

Once generated, this curve is utilized to determine the ignition angle for any target MFB50 angle. This generated or updated relationship is then used at 220 for determining the ignition angle for each cylinder firing event along with a target MFB50 angle selected at 218. The target MFB50 angle corresponds to a torque request, but could also vary depending upon other operating conditions indicated by sensor(s) 156. In some implementations, the controller 148 is configured to determine the target MFB50 angle based on a maximum brake torque (MBT) that can be generated by the engine 104. In other implementations, the controller 148 is configured to determine the target MFB50 angle based on a desired torque to be generated by the engine 104 (e.g., based on input via the driver interface 152). In yet other implementations, the controller 148 is configured to determine the target MFB50 angle based on a knock-limited torque to be generated by the engine 104.

Referring now to FIG. 3B and with continued reference to FIG. 2, the initial generation of the relationship (e.g., the polynomial function) during a cranking period is illustrated. This cranking period, as shown, occurs before cylinder event 20 and involves the engine 104 cranking to start. Once started around cylinder event 20, there is a blending to a normal (steady-state) operating period where normal spark ignition is occurring. The generated polynomial function is used after this cranking period to determine the ignition timing at 220. As shown, the ignition timing is very close to CA50 ignition timing and within an approximately +/−1.5 degree tolerance threshold. In FIGS. 3C-3D, however, a transient operating period is shown. Examples of the transient operating period include intermittent hard acceleration, during which engine speed and air charge vary widely (see FIG. 3D). As shown in FIG. 3C, the error from CA50 ignition timing is much larger and even exceeds the approximately +/−1.5 degree threshold.

Referring still to FIG. 3, an optional local update procedure could therefore be performed, e.g., when engine operating parameters from sensor(s) 156 indicate a transient operating period, such as engine load above a transient threshold. This involves an additional iteration of the update procedure (224, 228, and 232) at the firing frequency to locally improve the fit near the expected ignition timing. This works by predicting the ignition timing based on a target MFB50 angle for the firing cylinder (obtained based on parameter(s) from sensor(s) 156) using the polynomial fit at 220, executing the combustion model with this ignition timing at 224, and then generating a locally adjusted polynomial fit at 228 to use in the determination of the final ignition angle at 232 along with the target MFB50 angle selected at 218. The local adjustment of the polynomial fit is performed by shifting the offset term (i.e., shifting the global fit vertically) such that the polynomial passes through the result obtained from the execution of the combustion model. It will be appreciated that any other suitable adjustment to improve the accuracy of the polynomial in the vicinity of the expected spark timing could be used. As shown in FIG. 3E, the local update procedure results in superior ignition timing (virtually no CA50 of MFB50 error) without excessive additional computations (i.e., only a single additional iteration). This local update procedure could also be limited to when the controller 148 has additional processing capacity (i.e., the local update procedure would not take precedent over other functions of the controller 148).

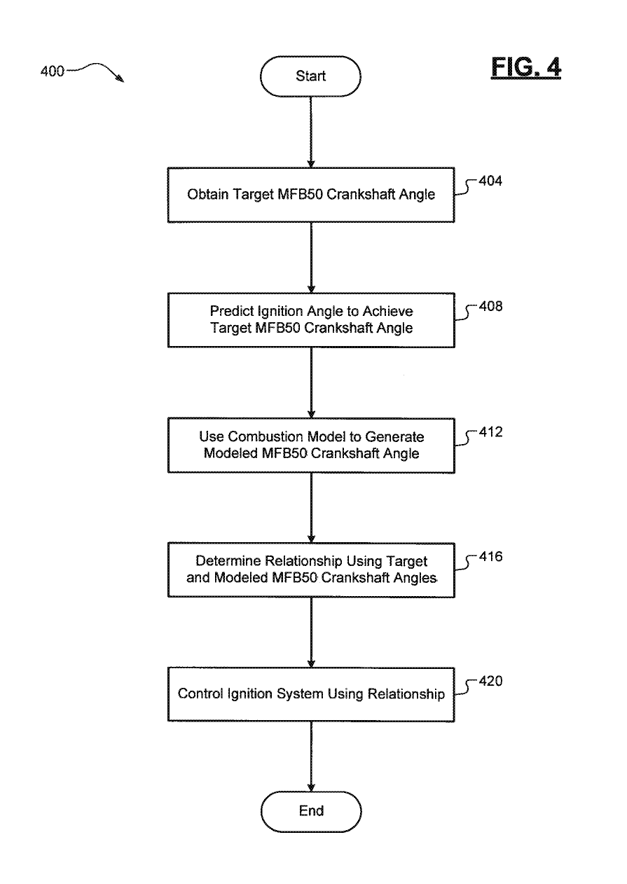

Referring now to FIG. 4, a flow diagram of an example method 400 for controlling combustion phasing using a physics-based combustion model is illustrated. At 404, the controller 148 obtains a target MFB50 angle. This target MFB50 angle could be either for a currently firing cylinder (e.g., based on a torque request) or could be one of the calibratable points of the relationship (e.g., the polynomial function) for updating. At 408, the controller 148 predicts an ignition angle to achieve the target MFB50 angle. At 412, the controller 148 uses a combustion model to generate a modeled MFB50 angle based on the predicted ignition angle. Based on the target and modeled MFB50 angles and the predicted ignition angle, at 416 the controller 148 determines a relationship between (e.g., a polynomial function for) MFB50 angle and ignition angle. At 420, the controller 148 controls the ignition system 128 (i.e., ignition timing) using the determined relationship. The method 400 then ends or returns to 404.

As previously discussed, it will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A control system for an engine having a crankshaft, the control system comprising:
an ignition system configured to generate spark within a cylinder of the engine; and
a controller configured to:
obtain a target angle of the crankshaft for an approximately 50% mass fraction burn (MFB50);
predict an ignition angle to achieve the target MFB50 angle, the ignition angle indicating an advance or retardation of spark timing;
using a combustion model, generate a modeled MFB50 angle based on the predicted ignition angle;
based on the target and modeled MFB50 angles and the predicted ignition angle, determine a relationship between MFB50 angle and ignition angle; and
control the ignition system using the determined relationship.

2. The control system of claim 1, wherein determining the relationship includes the controller generating a polynomial function relating MFB50 angle and ignition angle.

3. The control system of claim 2, wherein for a firing event of the cylinder, the controller is configured to:
determine the target MFB50 angle based on one or more measured engine operating parameters;
using the polynomial function, determine a target ignition timing based on the target MFB50 angle; and
control the ignition system using the target ignition timing.

4. The control system of claim 3, wherein the controller is configured to determine the target ignition timing a single time per cylinder firing event.

5. The control system of claim 3, wherein the controller is further configured to perform an update of the polynomial function for the firing event of the cylinder by:
predicting an ignition angle required to obtain the target MFB50 angle;
using the combustion model, obtaining a modeled MFB50 angle for the predicted ignition angle;
based on the predicted ignition and modeled MFB50 angles, updating the polynomial function;
using the updated polynomial function, determine a modified target ignition timing based on the target MFB50 angle; and
control the ignition system using the modified target ignition timing.

6. The control system of claim 5, wherein the controller is further configured to detect a transient operating condition of the engine, and wherein the controller performs the update of the polynomial function for the firing event of the cylinder in response to detecting the transient operating condition.

7. The control system of claim 5, wherein the controller only performs the update of the polynomial function for the firing event of the cylinder when it has additional processing capacity.

8. The control system of claim 3, further comprising one or more sensors configured to measure one or more engine operating parameters, wherein the controller is further configured to receive the one or more measured engine operating parameters.

9. The control system of claim 3, wherein the controller is further configured to determine the target MFB50 angle based on a maximum brake torque (MBT) that can be generated by the engine.

10. The control system of claim 3, wherein the controller is further configured to determine the target MFB50 angle based on a desired torque to be generated by the engine.

11. The control system of claim 3, wherein the controller is further configured to determine the target MFB50 angle based on a knock-limited torque to be generated by the engine.

12. The control system of claim 2, wherein the controller is configured to regenerate the polynomial function during each startup period of the engine.

13. The control system of claim 12, wherein the controller is further configured to perform an update of the polynomial function by:
obtaining the target MFB50 angle from one of a calibratable number of points in the polynomial function; and
based on the target and modeled MFB50 angles, updating the polynomial function.

14. The control system of claim 13, wherein the controller is configured to perform the update of the polynomial function at a predetermined rate.

15. The control system of claim 14, wherein the predetermined rate is not related to a firing rate of the engine.

16. The control system of claim 14, wherein the predetermined rate is approximately every ten milliseconds.

17. The control system of claim 14, wherein the predetermined rate is a function of firing frequency.

18. The control system of claim 17, wherein the predetermined rate is once per spark event.
